(19) United States
(12) Patent Application Publication
(10) Pub. No.: US 2018/0170090 A1
(43) Pub. Date: Jun. 21, 2018

(54) TRANSFER PRINTING PLATE ASSAMBLY

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Zongmin Tian, Beijing (CN); Xiangquan Zhai, Beijing (CN); Wenyu Zhang, Beijing (CN)

(21) Appl. No.: 15/579,088

(22) PCT Filed: May 10, 2017
(86) PCT No.: PCT/CN2017/083758

§ 371 Date: Dec. 1, 2017

(30) Foreign Application Priority Data
May 12, 2016 (CN) 201620428900.0

(51) Int. Cl. B41N 1/16; G02F 1/1337; G02F 1/13

(52) U.S. Cl. CPC B41N 1/16; G02F 1/1303; G02F 1/1337

(57) ABSTRACT

The present disclosure discloses a transfer printing plate assembly, which includes a transfer printing plate for transfer printing of aligning agent, and a printing cylinder for fixing the transfer printing plate. The transfer printing plate includes a first side, a second side opposite to the first side, and a first connection element at each of the first side and the second side. The printing cylinder includes a second connection element for engaging with the first connection element to prevent the transfer printing plate from shrinking in an axial direction of the printing cylinder when the transfer printing plate is fixed to the printing cylinder.

### CROSS-REFERENCE TO RELATED APPLICATION

This application is the U.S. national phase of PCT Application No. PCT/CN2017/083758 filed on May 10, 2017, which claims the priority of the Chinese patent application No. 201620428900.0 filed on May 12, 2016, which is incorporated herein by reference in its entirety.

### TECHNICAL FIELD

The present disclosure relates to the field of manufacture of liquid crystal products, and in particular to a transfer printing plate assembly.

### BACKGROUND

After recent decades of development, the technology and processes of thin film transistor liquid crystal display device (TFT-LCD) are maturing, and the thin film transistor liquid crystal display device has replaced the cold cathode diode display and becomes the mainstream product in the display field.

At present, the cell process for liquid crystal screens includes steps of first applying a sealant around a glass substrate, then dripping liquid crystal to a center of another glass substrate by using one drop filing process, and then bonding the two glass substrates in vacuum, and finally curing the sealant, thereby completing the cell process. During the process of manufacturing liquid crystal display (LCD) panels, in order to enable liquid crystal molecules to orient normally, one layer of polyimide (PI) film is coated on each of surfaces of an array substrate and a color substrate, and rubbing process is performed on the PI films to form align films, thereby realizing orientation of the liquid crystal molecules. Thus, a PI coater for the array substrate and the color substrate is important in the above process. The core of the PI coater is an asahikasei photosensitive resin (APR) plate. The design and fixation of the APR plate (i.e., a transfer printing plate) have an important impact on transfer effect on the alignment films.

### SUMMARY

In order to solve the above technical problem, the present disclosure provides a transfer printing plate assembly, which can improve reliability and stability of the transfer printing process of alignment films.

In order to achieve the above purpose, technical solutions adopted in the present disclosure are as follows.

A transfer printing plate assembly includes:

a transfer printing plate configured to transfer printing of aligning agent, and

a printing cylinder configured to fix the transfer printing plate,

wherein the transfer printing plate includes a first side, a second side opposite to the first side, and a first connection element at each of the first side and the second side,

wherein the printing cylinder includes a second connection element configured to engage with the first connection element to prevent the transfer printing plate from shrinking in a direction along an axis of the printing cylinder when the transfer printing plate is fixed to the printing cylinder.

Further, the first connection element is a protrusion and the second connection element is a groove which engages with the protrusion.

Further, the printing cylinder further includes an annular cutout provided in the printing cylinder at each position corresponding to the first connection element, and the annular cutout is inwardly depressed to form the groove.

Further, the printing cylinder further includes a main body, annular flanges and snap rings. The second connection element is disposed in the main body, each annular flange includes a first side, each annular flange protrudes from an outer periphery surface of the main body at a position adjacent the protrusion, each snap ring is detachably disposed on the printing cylinder and is located at the first side of each annular flange, the groove is defined between each snap ring and the corresponding annular flange, and the first side of each annular flange is one side of each annular flange adjacent a corresponding end portion of the printing cylinder.

Further, the printing cylinder further includes connection portions, the snap rings are detachably connected to the main body through the connection portions, respectively.

Further, one end of each connection portion is connected with the corresponding snap ring and the other end of each connection portion is connecting with the main body.

Further, the protrusion is made of a magnetic flexible material, the groove is enclosed by a magnetic rigid material, and the protrusion and the groove are connected by means of magnetic adsorption.

Further, the protrusion is made of magnetic resin.

Further, the protrusion is made of a flexible material, the groove is enclosed by a rigid material, and the protrusion and the groove are connected by means of interference fit.

Further, the protrusion is made of rubber or resin.

Further, the protrusion is made of rubber containing unsaturated functional groups, or a carbon chain polymer or a heterochain polymer.

Further, the first connection element is a protrusion, a first surface of the protrusion at the first side of the transfer printing plate faces a first surface of the protrusion at the second side of the transfer printing plate, the second connection element includes two annular flanges which protrude from two axial end portions of the printing cylinder, respectively, the two annular flanges have two opposite second surfaces, when the transfer printing plate is fixed to the printing cylinder, the first surface of each protrusion is in contact with the second surface of the corresponding annular flange.

Further, the transfer printing plate further includes a third side, an opposite fourth side, and a first fixing element, the printing cylinder further includes a second fixing element configured to engage with the first fixing element to position and fix the transfer printing plate to the printing cylinder, the first fixing element is disposed at each of the third side and the fourth side, the third side is adjacent and connected with the first side, and the second fixing element is disposed on the printing cylinder at each position corresponding to the first fixing element.

Further, each first fixing element is a groove, and the second fixing element is a convex portion which engages with the groove.

The present disclosure further provides a transfer printing plate assembly including a printing cylinder, and a transfer printing plate mounted on the printing cylinder. The transfer printing plate includes two first connection elements, the printing cylinder includes two second connection elements, two second connection elements are disposed at two axial end portions of the printing cylinder, respectively. The two first connection elements engage with the two second connection elements, respectively.

Further, the two first connection elements engage with the two second connection elements in an axial direction of the printing cylinder, respectively.

Further, the two first connection elements engage with the two second connection elements in an interference fit manner, respectively.

The present disclosure has benefit effects of preventing the transfer printing plate from shrinking in a direction along an axis of the printing cylinder when the transfer printing plate is fixed to the printing cylinder, and improving reliability and stability of the transfer printing process of alignment films.

### BRIEF DESCRIPTION OF THE DRAWINGS

FIG. 1 is a schematic view of a printing cylinder according to an embodiment of the present disclosure;

FIG. 2 is a side view of the printing cylinder shown in FIG. 1;

FIG. 3 is a schematic view of a transfer printing plate according to an embodiment of the present disclosure;

FIG. 4 is a side view of the transfer printing plate shown in FIG. 3;

FIG. 5 is a schematic view showing a connection state between a protrusion and a groove when the protrusion is not expanded according to an embodiment of the present disclosure;

FIG. 6 is a schematic view showing a connection state between the protrusion and the groove when the protrusion is expanded according to an embodiment of the present disclosure;

FIG. 7 is a schematic view showing a connection state between a protrusion and an annular flange according to an embodiment of the present disclosure, and

FIG. 8 is a schematic view of a printing cylinder according to an embodiment of the present disclosure.

### DETAILED DESCRIPTION OF THE EMBODIMENTS

Features and principles of the present disclosure are described hereinafter in combination with the drawings. Embodiments are only for illustrating the present disclosure, but are not intended to limit the scope of the present disclosure.

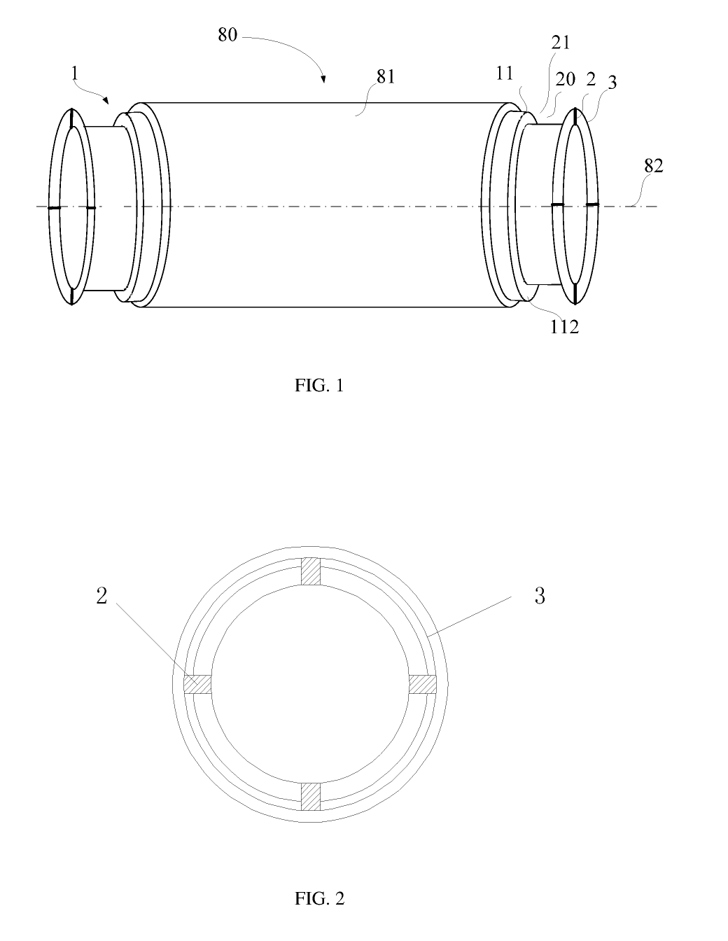

As shown in FIG. 1 to FIG. 4, one embodiment of the present disclosure provides a transfer printing plate assembly, which includes a transfer printing plate 60 for transfer printing of aligning agent, and a printing cylinder 80 for fixing the transfer printing plate 60. A first connection element 4 is disposed at each of a first side 62 and an opposite second side 64 of the transfer printing plate 60. The printing cylinder 80 includes a main body 81 and a second connection element 1 disposed at each of two ends of the main body 81 along an axial direction of the main body 81. The second connection element 1 engages with the first connection element 4 to prevent the transfer printing plate 60 from shrinking in a direction along an axis 82 of the printing cylinder 80 when the transfer printing plate 60 is fixed to the printing cylinder 80.

The presence of the first connection element 4 and the second connection element 1 enable the transfer printing plate 60 to be disposed on the printing cylinder 80 in a flattened manner, thereby preventing the transfer printing plate 60 from shrinking in the direction along the axis 82 of the printing cylinder 80 when the transfer printing plate 60 is fixed to the printing cylinder 80, and then improving reliability and stability of the transfer printing process of alignment films.

Specific structures of the first connection element 4 and the second connection element 1 may be in a variety of forms, as long as an engagement of the second connection element 1 and the first connection element 4 can achieve the purpose of preventing the transfer printing plate 60 from shrinking in the direction along the axis 82 of the printing cylinder 80 when the transfer printing plate 60 is fixed to the printing cylinder 80.

In one embodiment, the first connection element 4 is a protrusion, and the second connection element 1 is a groove 20 which engages with the protrusion.

When the transfer printing plate 60 is fixed to the printing cylinder 80, the protrusion engages with the groove 20. In the direction along the axis 82 of the printing cylinder 80, the groove 20 plays a role of blocking, so that the transfer printing plate 60 cannot shrink in the direction along the axis 82 of the printing cylinder 80.

Specific structures of the groove 20 may be in a variety of forms, as long as an engagement of the groove and the protrusion can prevent the transfer printing plate 60 from shrinking in the direction along the axis 82 of the printing cylinder 80 when the transfer printing plate 60 is fixed to the printing cylinder 80. Specific structures of the groove 20 of several embodiments of the present disclosure are described in the following.

First example: as shown in FIG. 8, an annular cutout 21 is provided in the printing cylinder 80 at each position corresponding to the first connection element 4, and the annular cutout 21 is inwardly depressed to form the groove 20.

The groove 20 may be directly fabricated in the printing cylinder 80 or integrally formed with the printing cylinder 80, thereby having simple structure and being easy to fabricate.

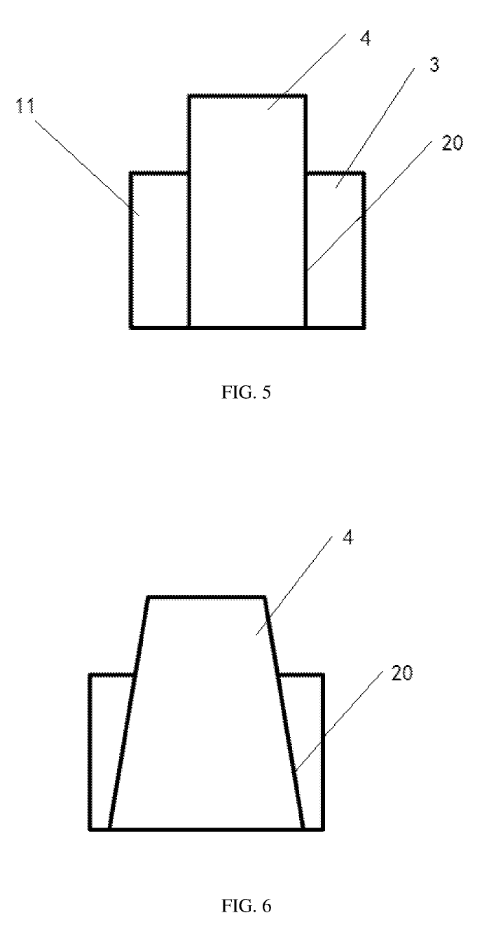

Second example: as shown in FIG. 1 and FIG. 5, an annular flange 11 protrudes from an outer periphery surface of the main body 81 of the printing cylinder 80 at a position adjacent each protrusion, and a snap ring 3 is disposed around the printing cylinder 80 at a first side 112 of each annular flange 11, the groove 20 is defined between each snap ring 3 and corresponding annular flange 11. The first side is one side of the annular flange 11 adjacent an end of the printing cylinder 80.

Optionally, a connection portion is disposed on the printing cylinder 80 for detachably connecting each snap ring 3 to the printing cylinder 80. The connection portion is a clip with one end connecting with the snap ring 3 and the other end connecting with the printing cylinder 80.

Since each snap ring 3 is detachably connected to the printing cylinder 80, it is easy to remove or assemble the printing cylinder 80.

Further, the protrusion may be made of a magnetic flexible material, and the groove 20 may be enclosed by a magnetic rigid material, i.e., the annular flange 11 and the snap ring 3 are made of the magnetic rigid material. The protrusion and the groove 20 may be connected by means of magnetic adsorption.

Further, the protrusion may be made of magnetic resin.

When the protrusion and the groove 20 are connected by means of magnetic adsorption between the magnetic flexible material and the magnetic rigid material, optionally, the protrusion may be made of magnetic resin. The magnetic resin is usually one of ferrite magnetic materials, and may be made by mixing ferrite powder (of which main ingredients include MO.6Fe2O3, where M includes Ba, Sr, Pb, or SrCa and LaCa and other composite ingredients) and synthetic resin, and then forming the magnetic resin through an extrusion forming process, a press forming process or an injection forming process. The magnetic resin is a magnet which is soft, flexible and twistable, and may be fabricated into a variety of complex shapes.

Further, the protrusion may be made of a flexible material, and the groove 20 may be enclosed by a rigid material, i.e., the annular flange 11 and the snap ring 3 are made of the rigid material. The protrusion and the groove 20 may be connected by means of interference fit.

Further, the protrusion may be made of rubber or magnetic resin.

When the protrusion is made of the flexible material and the groove 20 is enclosed by the rigid material, engagement between the protrusion and the groove may be realized by means of rigidity of the groove 20 and ductility of the protrusion. Specifically, the size of the groove 20 is constant, as shown in FIG. 5, the size of the protrusion fit the size of the groove 20. Since the protrusion is made of flexible material (which may be rubber or resin, such as isoprene polymer rubber), which may be heated to expand (temperature of heating is usually 60 centigrade degrees) and cannot be restored after cooled, or which may expand easily in the presence of mineral oil or gasoline, the protrusion itself expands by the above means, thereby realizing interference fit between the groove 20 and the protrusion, as shown in FIG. 6.

The materials available for the protrusion include a series of rubber containing unsaturated functional groups, such as styrene butadiene rubber (SBR), isobutylene isoprene rubber (IIR), hydrogenated nitrile butadiene rubber (HNBR), ethyl-ene propylene diene methylene (EPDM), nitrile-butadiene rubber (NBR), or a carbon chain polymer such as polyethylene and polystyrene, or a heterochain polymer such as polyoxymethylene, polyamide, polysulfone, polyether or other synthetic resins.

The protrusion may be made of flexible organic matter such as rubber or resin, and the protrusion expands due to internal reorganization of the organic matter caused by heating. In addition, the engagement between the protrusion and the groove may also be achieved by chemical material or glue-like material.

In addition, the interference fit between the protrusion and the groove 20 may be achieved by an elastic deformation of the protrusion itself. An area of an opening of the groove 20 away from the printing cylinder 80 is smaller than an area of a bottom portion of the groove close to the printing cylinder 80. When the protrusion is engaged in the groove 20, the protrusion is snapped into the groove 20 by means of elastic deformation of the protrusion. When the area of the opening of the groove 20 is smaller than an area of any surface of the protrusion, it is difficult for the protrusion to escape from the groove 20.

The interference fit between the protrusion and the groove 20 facilitates fixed connection between the transfer printing plate 60 and the printing cylinder 80, and plays a role of preventing the transfer printing plate 60 from shrinking in the direction along the axis 82 of the printing cylinder 80 during the transfer printing process.

As shown in FIG. 4, the first connection elements 4 are disposed on a surface of the transfer printing plate opposite to a transfer printing surface 10, so as not to affect transfer effect.

The presence of the snap ring 3 can prevent movement of the transfer printing plate 60 during the transfer printing process, so as not to affect transfer effect of the aligning agent.

As shown in FIG. 2, a projection of the snap ring 3 is located within lateral end surfaces of the printing cylinder 80, a central point of the snap ring 3 and a central point of a cross section of the printing cylinder 80 are at an identical straight line, and a diameter of the snap ring 3 is smaller than a diameter of the cross section of the printing cylinder 80 so as to prevent the transfer printing effect from being affected by a height of the snap ring 3 being greater than a height of the printing cylinder 80.

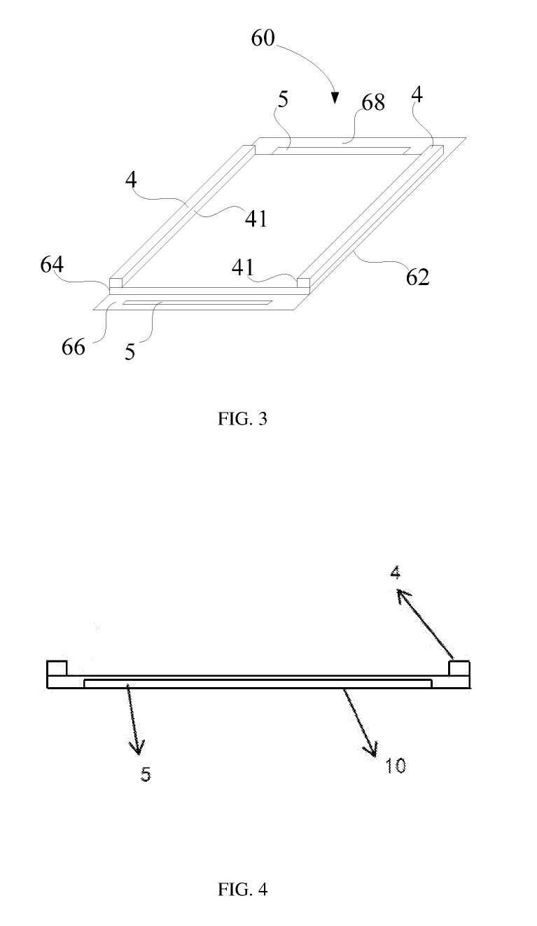

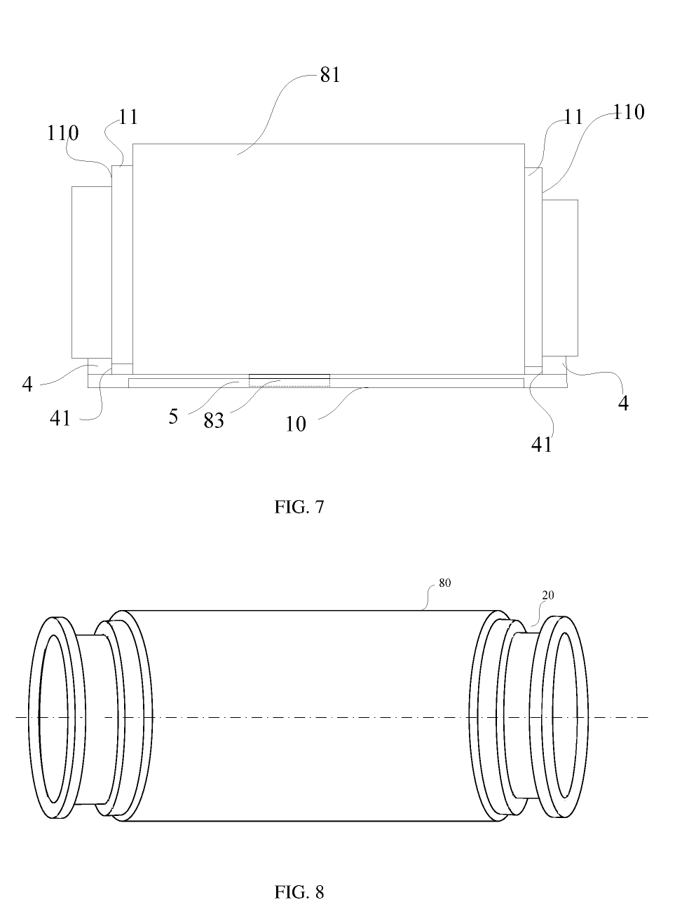

Third example, as shown in FIG. 3, the first connection element 4 is a protrusion, a first surface 41 of the protrusion at a first side 62 of the transfer printing plate 60 faces a first surface 41 of the protrusion at a second side 64 of the transfer printing plate 60 (i.e., one surface of the protrusion at the first side 62 of the transfer printing plate 60, which faces the protrusion at the second side 64 of the transfer printing plate 60, is the first surface 41; similarly, one surface of the protrusion at the second side 64 of the transfer printing plate 60, which faces the protrusion at the first side 62 of the transfer printing plate 60, is the first surface 41). As shown in FIG. 7, the second connection element 1 includes two annular flanges 11 which protrude from two axial end portions of the main body 81 of the printing cylinder, respectively. The two annular flanges 11 have two opposite second surfaces 110 (one surface of one annular flange away from the other annular flange 11 is the second surface 110, i.e., one surface of one annular flange, which is parallel to a lateral end surface of the printing cylinder and is close to the corresponding end portion of the printing cylinder, is the second surface 110). As shown in FIG. 7, when the transfer printing plate 60 is fixed to the printing cylinder 80, the first surface 41 of each protrusion is in contact with the second surface 110 of the corresponding annular flange.

When the transfer printing plate 60 is fixed to the printing cylinder 80, the first surface 41 of each protrusion is in contact with the second surface 110 of the corresponding annular flange 11, i.e., the two protrusions disposed on opposite sides of the transfer printing plate 60 are located outside of the two corresponding annular flanges 11 of the printing cylinder 80, thereby preventing the transfer printing plate 60 from shrinking in the direction along the axis of the printing cylinder 80 when the transfer printing plate 60 is fixed to the printing cylinder 80. Further, the presence of the annular flanges 11 facilitates fixed connection between the transfer printing plate 60 and the printing cylinder 80.

Further, as shown in FIG. 3, a first fixing element 5 is disposed at each of a third side 66 and an opposite fourth side 68 of the transfer printing plate 60, and the third side 66 is adjacent and connected with the first side 62. As shown in FIG. 7, a second fixing element 83 is disposed on the printing cylinder 80 at each position corresponding to the first fixing element 5, and the second fixing element 83 engages with the first fixing element 5 to position and fix the transfer printing plate 60 to the printing cylinder 80.

The engagement between the first fixing element 5 and the second fixing element ensures stability of connection between the transfer printing plate 60 and the printing cylinder 80.

Further, the first fixing element 5 is a first clamp portion, and the second fixing element is a second clamp portion which engages with the first clamp portion.

Further, the first clamp portion may be a groove, and the second clamp portion may be a convex portion which engages with the groove.

It should be noted that, specific structures of the first fixing element 5 and the second fixing element are not limited to the above structures, as long as the first fixing element 5 and the second fixing element can secure the transfer printing plate 60 to the printing cylinder 80.

It should be noted that, FIG. 5 to FIG. 7 are schematic diagrams, a height difference between the groove 20 and the first connection element 4 (protrusion) shown in FIG. 5 and FIG. 6 is only schematic, and a height difference between the first connection element 4 (protrusion) and the annular flange 11 shown in FIG. 7 is also only schematic. In actual application, according to actual needs, the height difference between the groove 20 and the first connection element 4 (protrusion) may be greater than or equal to 0, and the height difference between the first connection element 4 (protrusion) and the annular flange 11 may also be greater than or equal to 0.

It may be appreciated that, the above embodiments are optional embodiments of the present disclosure. A person skilled in the art may make further modifications and improvements without departing from the principle of the present disclosure, and these modifications and improvements shall also fall within the scope of the present disclosure.

1. A transfer printing plate assembly, comprising:
a transfer printing plate configured to transfer printing of aligning agent, and
a printing cylinder configured to fix the transfer printing plate,
wherein the transfer printing plate includes a first side, a second side opposite to the first side, and a first connection element at each of the first side and the second side,
wherein the printing cylinder includes a second connection element configured to engage with the first connection element to prevent the transfer printing plate from shrinking in an axial direction of the printing cylinder when the transfer printing plate is fixed to the printing cylinder.

2. The transfer printing plate assembly of claim 1, wherein the first connection element includes a protrusion and the second connection element includes a groove which engages with the protrusion.

3. The transfer printing plate assembly of claim 2, wherein the printing cylinder further includes an annular cutout provided in the printing cylinder at each position corresponding to the first connection element, and the annular cutout is inwardly depressed to form the groove.

4. The transfer printing plate assembly of claim 2, wherein the printing cylinder further includes a main body, annular flanges and snap rings,
the second connection element is disposed in the main body,
each annular flange includes a first side,
each annular flange protrudes from an outer periphery surface of the main body at a position adjacent the protrusion, each snap ring is detachably disposed on the printing cylinder and is located at the first side of each annular flange,
the groove is defined between each snap ring and the corresponding annular flange, and the first side of each annular flange is one side of each annular flange adjacent a corresponding end portion of the printing cylinder.

5. The transfer printing plate assembly of claim 4, wherein the printing cylinder further includes connection portions, the snap rings are detachably connected to the main body through the connection portions, respectively.

6. The transfer printing plate assembly of claim 5, wherein one end of each connection portion is connected with the corresponding snap ring and the other end of each connection portion is connecting with the main body.

7. The transfer printing plate assembly of claim 2, wherein the protrusion is made of a magnetic flexible material, the groove is enclosed by a magnetic rigid material, and the protrusion and the groove are connected by means of magnetic adsorption.

8. The transfer printing plate assembly of claim 7, wherein the protrusion is made of magnetic resin.

9. The transfer printing plate assembly of claim 2, wherein the protrusion is made of a flexible material, the groove is enclosed by a rigid material, and the protrusion and the groove are connected by means of interference fit.

10. The transfer printing plate assembly of claim 9, wherein the protrusion is made of rubber or resin.

11. The transfer printing plate assembly of claim 10, wherein the protrusion is made of rubber containing unsaturated functional groups, or a carbon chain polymer or a heterochain polymer.

12. The transfer printing plate assembly of claim 1, wherein the first connection element includes a protrusion, a first surface of the protrusion at the first side of the transfer printing plate faces a first surface of the protrusion at the second side of the transfer printing plate, the second connection element includes two annular flanges which protrude from two axial end portions of the printing cylinder, respectively, the two annular flanges have two opposite second surfaces, the first surface of each protrusion is in contact with the second surface of the corresponding annular flange when the transfer printing plate is fixed to the printing cylinder.

13. The transfer printing plate assembly of claim 1, wherein the transfer printing plate further includes a third side, a fourth side opposite to the third side, and a first fixing element,
the printing cylinder further includes a second fixing element configured to engage with the first fixing element to position and fix the transfer printing plate to the printing cylinder,
the first fixing element is disposed at each of the third side and the fourth side, the third side is adjacent and connected with the first side, and the second fixing element is disposed on the printing cylinder at each position corresponding to the first fixing element.

14. The transfer printing plate assembly of claim 13, wherein each first fixing element includes a groove, and the second fixing element includes a convex portion which engages with the groove.

15. A transfer printing plate assembly comprising:
a printing cylinder, and
a transfer printing plate mounted on the printing cylinder,
wherein the transfer printing plate includes two first connection elements, the printing cylinder includes two second connection elements, two second connection elements are disposed at two axial end portions of the printing cylinder, respectively,
the two first connection elements engage with the two second connection elements, respectively.

16. The transfer printing plate assembly of claim 15, wherein the two first connection elements engage with the two second connection elements in an axial direction of the printing cylinder, respectively.

17. The transfer printing plate assembly of claim 16, wherein the two first connection elements engage with the two second connection elements in an interference fit manner, respectively.

18. The transfer printing plate assembly of claim 10, wherein the protrusion is made of materials including at least one of styrene butadiene rubber (SBR), isobutylene isoprene rubber (IIR), hydrogenated nitrile butadiene rubber (HNBR), ethyl-ene propylene diene methylene (EPDM) and nitrile-butadiene rubber (NBR).

19. The transfer printing plate assembly of claim 10, wherein the protrusion is made of material including at least one of polyethylene and polystyrene.

20. The transfer printing plate assembly of claim 10, wherein the protrusion is made of material including at least one of polyoxymethylene, polyamide, polysulfone, and polyether.
